(19) United States
(12) Patent Application Publication
(10) Pub. No.: US 2004/0257568 A1
(43) Pub. Date: Dec. 23, 2004

(54) Dimension measuring method, system and program

(75) Inventor: Takeshi Yamane, Kawasaki-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/868,030

(22) Filed: Jun. 16, 2004

(30) Foreign Application Priority Data
Jun. 23, 2003 (JP) 2003-178240
Apr. 13, 2004 (JP) 2004-118050

(51) Int. Cl. G01B 11/00; G01B 11/14

(52) U.S. Cl. 356/394; 356/625

(57) ABSTRACT

A dimension measuring method of measuring a dimension of a pattern on a photomask. This method comprises acquiring, using an optical microscope, an image containing the pattern on the photomask, acquiring a simulated image from photomask design data corresponding to the acquired image, and comparing the image with the simulated image based on a determination condition. If the comparison result does not satisfy the determination condition, the operation of acquiring the simulated image and comparing the image acquired by the optical microscope with the simulated image is repeated after a pattern dimension included in the photomask design data is changed, until the comparison result satisfies the determination condition.

### CROSS-REFERENCE TO RELATED APPLICATIONS

This application is based upon and claims the benefit of priority from prior Japanese Patent Applications No. 2003-178240, filed Jun. 23, 2003; and No. 2004-118050, filed Apr. 13, 2004, the entire contents of both of which are incorporated herein by reference.

### BACKGROUND OF THE INVENTION

1. Field of the Invention

The present invention relates to a dimension measuring method for measuring the dimensions of a pattern on a photomask, and more particularly to a method for performing dimension measurement based on image data indicating a mask pattern obtained by an optical microscope.

It also relates to a dimension measuring system for realizing the method and a program for dimension measurement. It further relates to a method for measuring the configuration of a pattern on a photomask, and a photomask manufacturing method using the photomask pattern configuration measuring method.

2. Description of the Related Art

Optical microscopes are generally used as dimension measuring apparatuses for measuring the dimensions of a pattern on a photomask, because, for example, they do not significantly damage the photomask. FIGS. 10A to 10C are views useful in explaining a conventional dimension measuring method using an optical microscope. Specifically, FIG. 10A shows a to-be-measured pattern on a photomask, FIG. 10B an image obtained by the optical microscope, and FIG. 10C an image level profile.

The pattern as shown in FIG. 10A is photographed using an optical microscope, thereby obtaining the image as shown in FIG. 10B. To measure the dimensions of the image along a dimension measuring line (1-3), the image level profile as shown in FIG. 10C is acquired. Based on the image level profile, a distance (1-6) between portions whose level reaches a predetermined threshold value is output as a measurement dimension. In general, the threshold value is defined as a value related to the maximum value (1-8) and the minimum value (1-9), such as a median value therebetween, so that the measurement dimension (1-6) corresponds to an actual value (1-7).

However, if the dimension (1-11) of a to-be-measured pattern is as small as the light wavelength of the light source of the optical microscope as shown in FIG. 11A, the pattern cannot sufficiently be resolved by the light of the microscope, whereby the image as shown in FIG. 11B is acquired. In this case, the image level profile is varied as illustrated in FIG. 11C, in which the maximum value (1-14) of the image level is significantly lower than the standard value (1-8). Accordingly, the measurement dimension (1-15) significantly differs from an actual dimension (1-11), which means the degradation of measurement reliability.

Further, Jpn. Pat. Appln. KOKAI Publication No. 2002-81914 has proposed a dimension inspecting method. In this method, edges adjacent to the width-directional opposite edges of a designed pattern are detected and used to determine whether a semiconductor wafer is aligned with a circuit pattern.

However, also in this method, if the pattern is too small, the width dimension differing from the actual one may be detected because of the limitation of the resolution of optical microscopes. Thus, the differences between the dimensions of a to-be-inspected pattern and those of a reference pattern cannot accurately be detected, thereby degrading the reliability of measurement.

As stated above, in the conventional methods for optically inspecting a photomask pattern, the dimensions of a small pattern may be detected to be significantly different from the actual dimensions because of the insufficient resolution of the optical microscope.

### BRIEF SUMMARY OF THE INVENTION

According to a first aspect of the invention, there is provided a dimension measuring method of measuring a dimension of a pattern on a photomask subjected to pattern exposure for a semiconductor device, comprising:

acquiring, using an optical microscope, an image containing the pattern on the photomask;

acquiring a simulated image from photomask design data corresponding to the image acquired by the optical microscope, by simulating an image to be acquired by the optical microscope;

comparing the image acquired by the optical microscope with the simulated image acquired by the simulation, based on a predetermined determination condition;

determining a pattern dimension, included in the photomask design data, to be a measured pattern dimension, if the comparison result satisfies the determination condition; and

repeating, until the comparison result satisfies the determination condition, an operation of acquiring the simulated image and comparing the image acquired by the optical microscope with the simulated image after changing the pattern dimension included in the photomask design data, if the comparison result does not satisfy the determination condition, thereby determining, to be the measured pattern dimension, a pattern dimension included in finally obtained photomask design data.

According to a second aspect of the invention, there is provided a dimension measuring system for measuring a dimension of a pattern on a photomask subjected to pattern exposure for a semiconductor device, comprising:

an image acquisition section which acquires, using an optical microscope, an image containing the pattern on the photomask;

a simulated-image acquisition section which acquires a simulated image from photomask design data corresponding to the image acquired by the image acquisition section, by simulating an image to be acquired by the optical microscope;

a comparator which compares the image acquired by the image acquisition section with the simulated image acquired by the simulated-image acquisition section, based on a predetermined determination condition;

a change section which changes a pattern dimension included in the photomask design data such that the comparison result of the comparator satisfies the determination condition; and

an output section which outputs, as a measured pattern dimension value, a pattern dimension included in photomask design data finally changed by the change section.

According to a third aspect of the invention, there is provided a program stored in a computer readable recording medium, which enables a computer to measure a dimension of a pattern on a photomask subjected to pattern exposure for a semiconductor device, the program instructing the computer to perform the following (A) to (E):

(A) receiving, from an optical microscope, an image containing the pattern on the photomask;

(B) acquiring a simulated image from photomask design data corresponding to the received image, by simulating an image to be acquired by the optical microscope;

(C) comparing the image with the simulated image based on a predetermined determination condition;

(D) changing a pattern dimension included in the photomask design data, and executing the steps (B) and (C);

(E) repeating the step (D) until the comparison result satisfies the determination condition, and determining, to be a measured pattern dimension, a pattern dimension included in finally obtained photomask design data.

According to a fourth aspect of the invention, there is provided a configuration measuring method of measuring a configuration of a pattern on a photomask subjected to pattern exposure for a semiconductor device, comprising:

acquiring, using an optical microscope, an image containing the pattern on the photomask;

acquiring a simulated image from photomask design data corresponding to the image acquired by the optical microscope, by simulating an image to be acquired by the optical microscope;

comparing the image acquired by the optical microscope with the simulated image acquired by the simulation, based on a predetermined determination condition;

outputting the photomask design data as a pattern configuration if the comparison result satisfies the determination condition; and

repeating, until the comparison result satisfies the determination condition, an operation of acquiring the simulated image and comparing the image acquired by the optical microscope with the simulated image after changing a pattern configuration included in the photomask design data, if the comparison result does not satisfy the determination condition, thereby outputting, as a measured pattern configuration, a pattern configuration included in finally obtained photomask design data.

According to a fifth aspect of the invention, there is provided a photomask manufacturing method for drawing a pattern of a semiconductor circuit on a mask substrate, comprising:

acquiring, using an optical microscope, an image containing the pattern on a photomask;

acquiring a simulated image from photomask design data corresponding to the image acquired by the optical microscope, by simulating an image to be acquired by the optical microscope;

comparing the image acquired by the optical microscope with the simulated image acquired by the simulation, based on a predetermined determination condition;

outputting the photomask design data as a pattern configuration if the comparison result satisfies the determination condition;

repeating, until the comparison result satisfies the determination condition, an operation of acquiring the simulated image and comparing the image acquired by the optical microscope with the simulated image after changing a pattern configuration included in the photomask design data, if the comparison result does not satisfy the determination condition, thereby outputting, as a measured pattern configuration, a pattern configuration included in finally obtained photomask design data; and

drawing a pattern on a mask substrate based on the output photomask design data.

### BRIEF DESCRIPTION OF THE SEVERAL VIEWS OF THE DRAWING

FIG. 1 is a schematic view illustrating a photomask dimension measuring system according to an embodiment of the invention;

FIG. 2 is a flowchart useful in explaining the photomask dimension measuring system of the embodiment;

FIG. 3 is a view illustrating a to-be-measured pattern;

FIG. 4 is a view illustrating an image acquired by an optical microscope;

FIG. 5 is a view illustrating design data concerning a photomask;

FIG. 6 is a view illustrating a simulated image;

FIG. 7 is a view useful in explaining the difference in image level between an image and simulated image;

FIG. 8 is a view illustrating the positional displacement of an image level distribution;

FIGS. 9A to 9C are graphs illustrating changes in the differences between image levels and between integral values, and in the amount of displacement;

FIGS. 10A to 10C are views useful in explaining a conventional dimension measuring method used by an optical microscope; and

FIGS. 11A to 11C are other views useful in explaining the conventional dimension measuring method used by the optical microscope.

### DETAILED DESCRIPTION OF THE INVENTION

An embodiment of the invention will be described in detail with reference to the accompanying drawings.

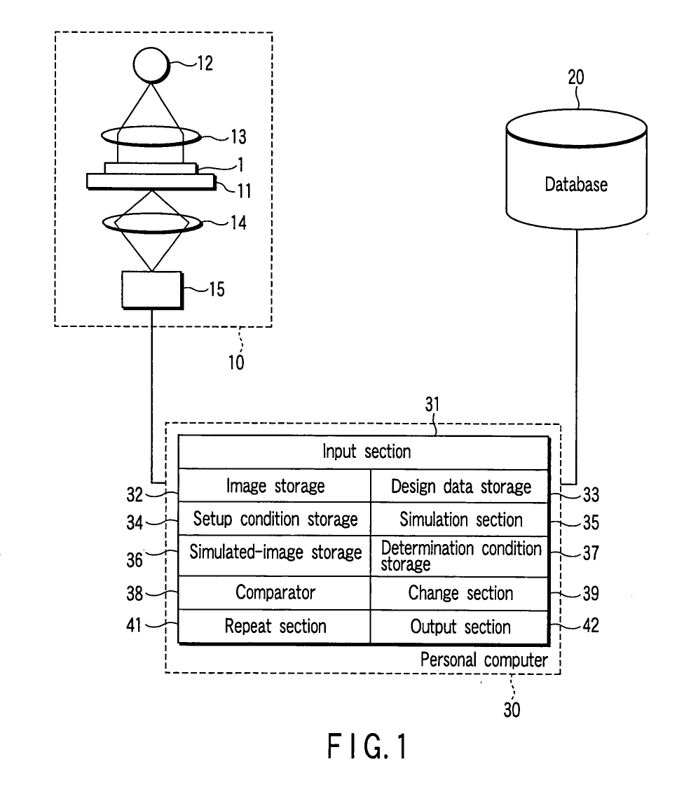

FIG. 1 is a schematic view illustrating a photomask dimension measuring system according to the embodiment of the invention.

This system comprises an optical microscope 10 for acquiring an image that includes a pattern on a photomask 1, a database 20 for storing design data concerning all photomasks, and the measured values of the light transmittances and phase-shift values of the photomasks, and a personal computer 30 for performing various processes.

The optical microscope 10 includes various optical components for forming an image of a pattern on the photomask 1, such as a stage 11 that can be moved to an arbitrary position with the photomask 1 placed thereon, a light source 12, a condensing lens 13 and objective 14. The microscope 10 further includes a camera 15 for picking up the image of the pattern.

The personal computer 30 includes an input section 31, storages 32, 33, 34, 36 and 37, simulation section 35, comparator 38, change section 39, repeat section 41 and output section 42. The input section 31 receives, from the outside, data concerning a dimension measuring position on the photomask. The storages 32, 33, 34, 36 and 37 store various types of data. The simulation section 35 performs simulation. The comparator 38 compares an image with a simulated image. The change section 39 changes pattern dimensions, pattern configurations and pattern positions included in the design data. The repeat section 41 causes the comparator and simulation section to repeat simulation and comparison, respectively. The output section 42 outputs a dimension measurement result.

The setup condition storage 34 stores setup conditions for the optical microscope 10, such as the wavelength of the light source 12, the NA of the condensing lens 13, and the NA of the objective 14. The determination condition storage 37 stores determination conditions for comparing an image acquired from the optical microscope 10 with a simulated image.

When an instruction is supplied to the stage 11 in accordance with the dimension measuring position input to the input section 31, the image storage 32 stores an image picked by the camera 15. The design data storage 33 acquires, from the database, design data corresponding to the image stored in the image storage 32, and stores the data.

The simulation section 35 simulates an image, to be observed with the optical microscope 10, from the design data stored in the design data storage 33 and information, concerning the optical microscope 10, stored in the setup condition storage 34. The resultant simulated image is stored in the simulated-image storage 36.

The comparator 38 compares the image stored in the image storage 32 with the simulated image stored in the simulated-image storage 36, based on the determination conditions stored in the determination condition storage 37. If the determination conditions are not satisfied, the corresponding pattern dimension, configuration and position stored in the design data storage 33 are changed by the change section 39, and are overwritten with the changed data in the storage 33. Accordingly, the simulation result of the simulation section 35 becomes different, and the simulated image stored in the simulated-image storage 36 is updated.

After that, the repeat section 41 causes the change section 39 and simulation section 35 to repeat the changing operation and simulation, respectively, until the determination conditions are satisfied in the comparator 38. After the repeat section 41 finishes the repetition process, the output section 42 outputs the dimension of the pattern at the dimension measuring position included in the design data stored in the design data storage 33.

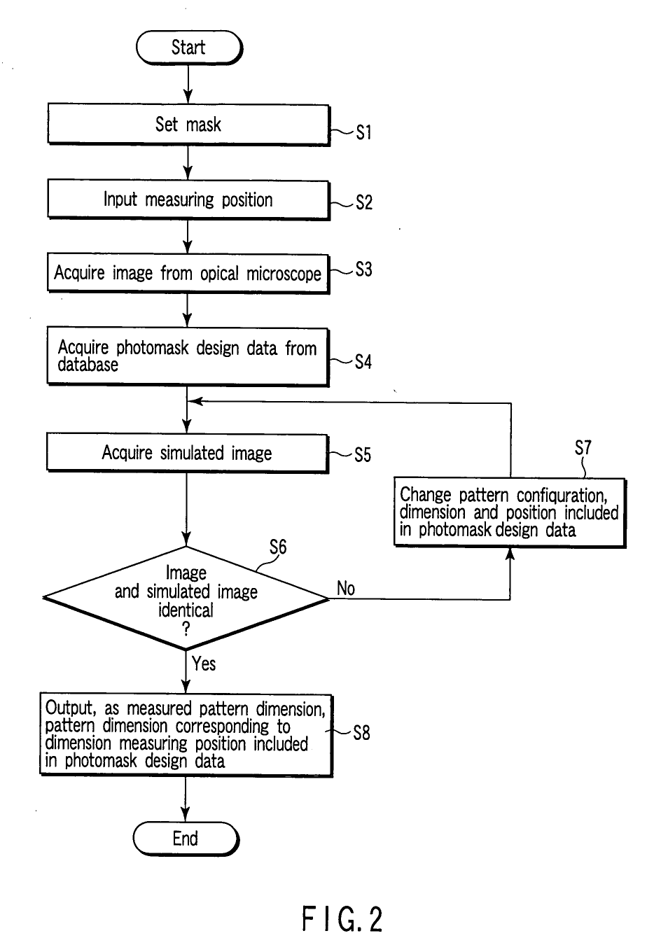

Referring now to the flowchart of FIG. 2, a description will be given of the dimension measuring method of the embodiment.

Firstly, the operator sets the photomask 1 in the optical microscope 10 (step S1). Subsequently, the operator inputs the name of the photomask 1 and the dimension measuring position on the photomask 1 to the input section 31 of the personal computer 30 (step S2).

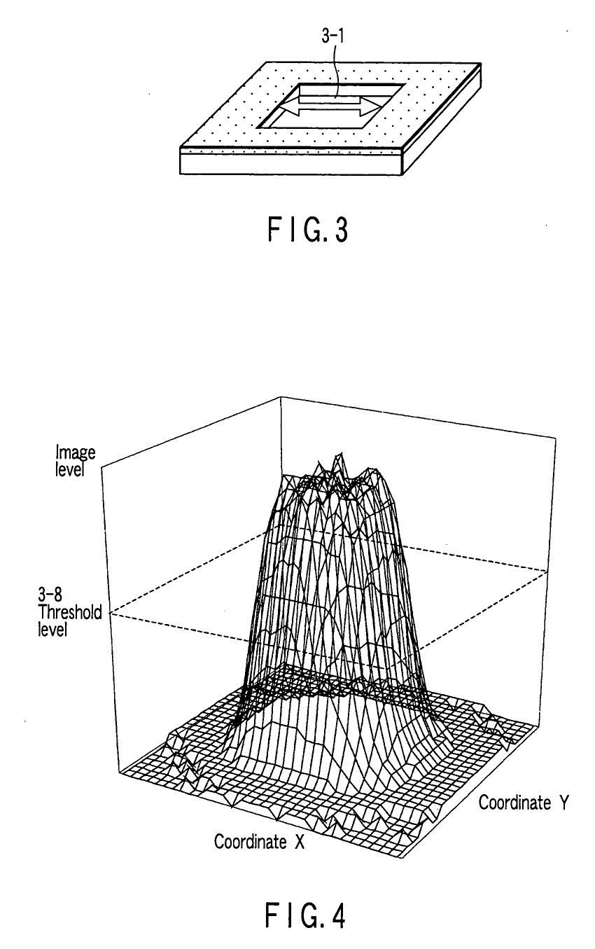

After that, the optical microscope 10 moves the stage 11 to the dimension measuring position (3-1) on the photomask 1 as shown in FIG. 3, thereby acquiring an image of a pattern that includes the dimension measuring position (step S3). FIG. 3 shows the pattern including the dimension measuring position, while FIG. 4 shows an image acquired by the optical microscope 10.

Thereafter, based on the name of the photomask 1 and the dimension measuring position thereon input at the step S2, the personal computer 30 acquires, from the database 20, design data on the to-be-measured portion, the measured values of optical characteristics of the portion, such as the light transmittance and phase-shift values, or values into which the optical characteristic values are converted, based on the measurement value of the thickness of the opaque film on the photomask. The design values of the optical characteristics included in the design data are replaced with the measured values or conversion values, which are stored in the design data storage 33 (step S4). FIG. 5 shows photomask design data, and (3-17) therein indicates the output value.

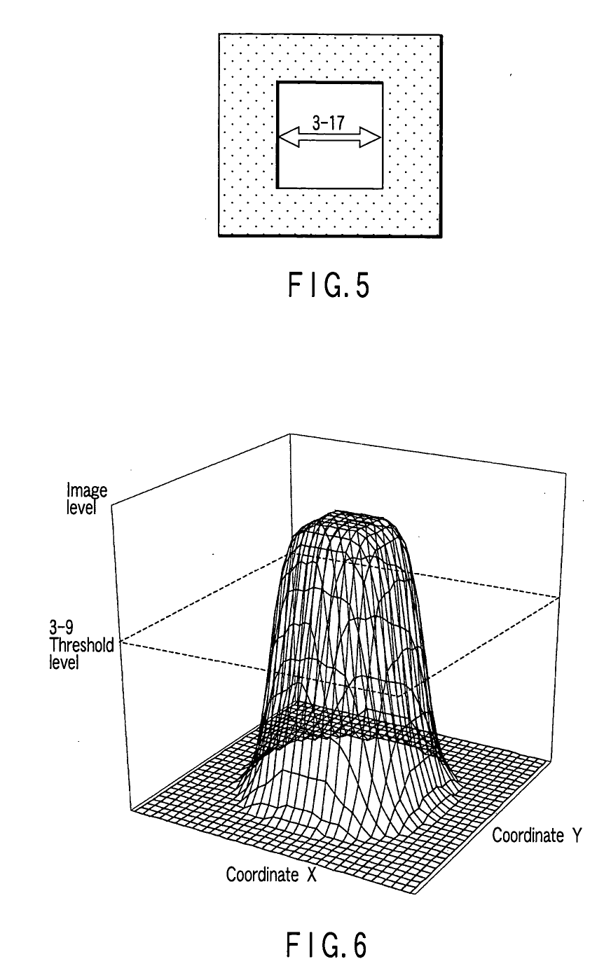

After that, the personal computer 30 uses prestored information concerning the optical microscope 10, to simulate an image acquired by the microscope 10. The resultant simulated image is stored in the simulated-image storage 36 (step S5). FIG. 6 shows a simulated image.

The comparator 38 determines whether the image shown in FIG. 4 is identical to the simulate image shown in FIG. 6, using at least one of the following determination conditions (A) to (H) (step S6):

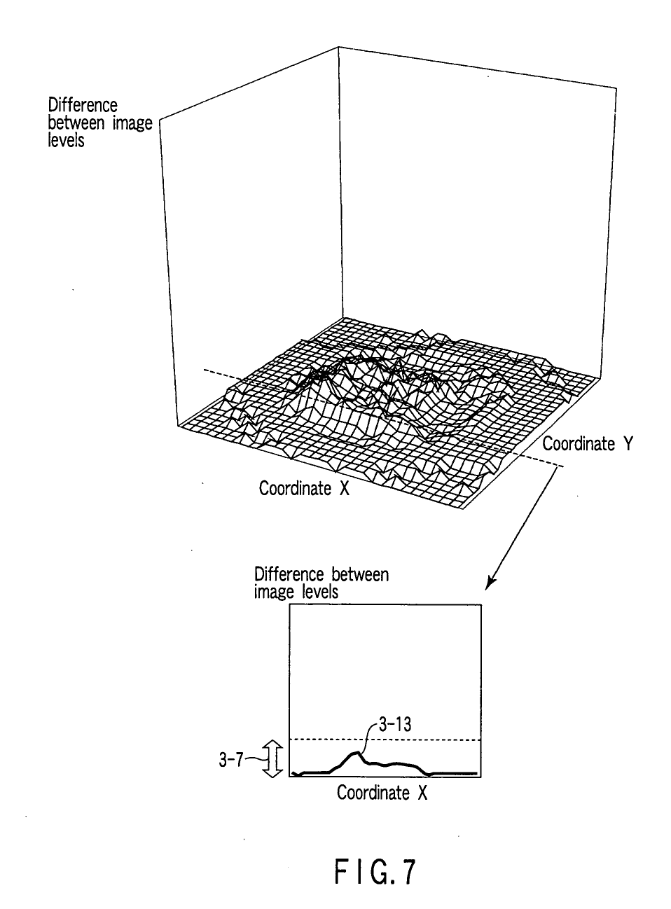

(A) The difference between the image levels of an image and simulated image at each pair of coordinates is obtained as shown in FIG. 7, and if the difference falls within a predetermined range (3-7), it is determined that the images are identical to each other.

(B) The integral values of image levels obtained from the respective predetermined regions of an image and simulated image are calculated, and if the difference between the integral values falls within a predetermined range, it is determined that the images are identical to each other.

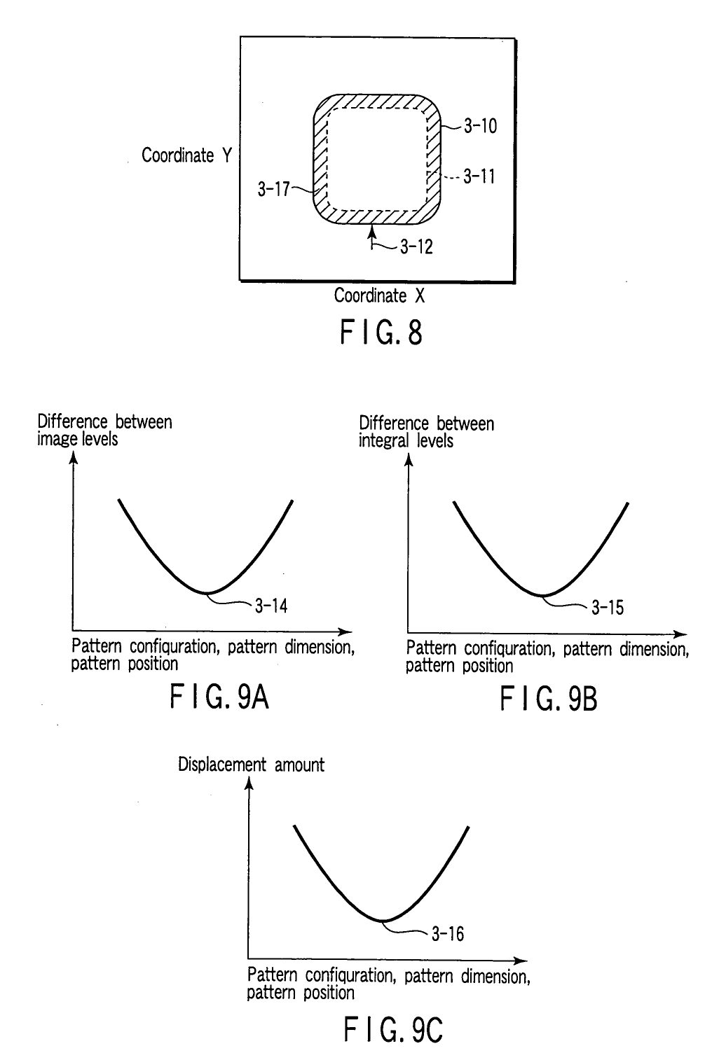

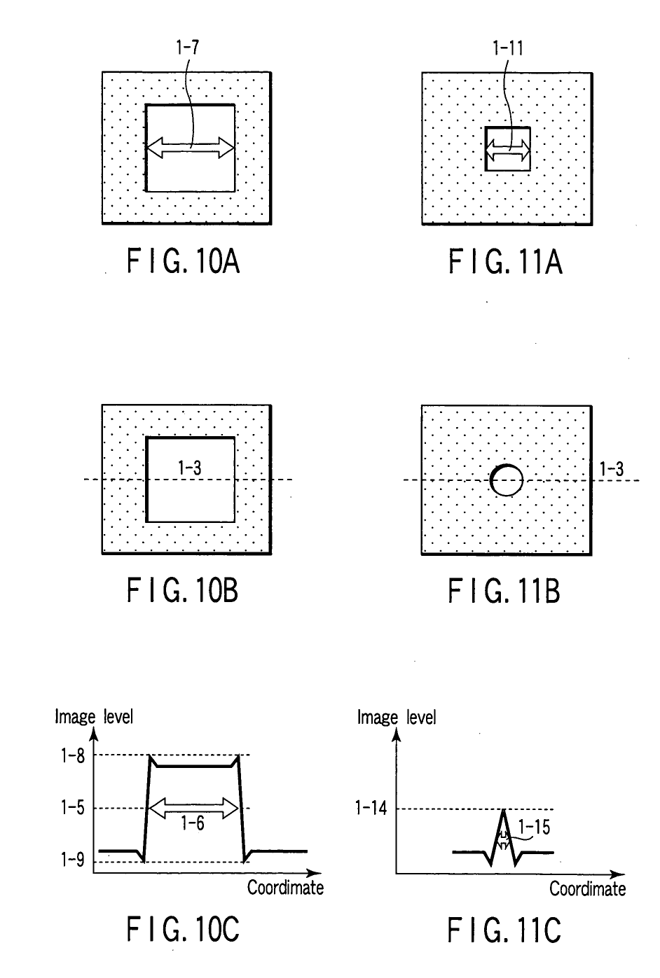

(C) As shown in FIG. 8, the positions (3-10, 3-11) on an image and simulated image, at which the image level reaches respective predetermined threshold values (3-8, 3-9), are plotted, and the area of the region defined by the position (3-10) and the area of the region defined by the position (3-11) are calculated. If the difference between these areas falls within a predetermined range, it is determined that the images are identical to each other.

(D) As shown in FIG. 8, the positions (3-10, 3-11) on an image and simulated image, at which the image level reaches respective predetermined threshold values (3-8, 3-9), are plotted. If the distance (3-12) between an arbitrary one of the position (3-10) and the one of the position (3-11) closest to the arbitrary one falls within a predetermined range, it is determined that the images are identical to each other.

(E) As shown in FIG. 7, the image levels of an image and simulated image at each pair of coordinates are obtained, and a value representing the difference between the image levels, such as the maximum difference (3-13) or average difference, is calculated. If the value representing the image level difference becomes minimum (3-14) as shown in FIG. 9A when the corresponding pattern dimension, pattern configuration and pattern position included in design data are changed at step S7, as described later, it is determined that the images are identical to each other. However, if the process at step S5 is performed for the first time, the maximum or average difference cannot be calculated, therefore the process skips over step S6 to step S7.

(F) The integral values of the image levels of an image and simulated image in predetermined coordinates regions are obtained. If the difference between the integral values of the image levels of the images becomes minimum (3-15) as shown in FIG. 9B when the corresponding pattern dimension, pattern configuration and pattern position included in design data are changed at step S7, it is determined that the images are identical to each other. However, if the process at step S5 is performed for the first time, the difference cannot be calculated, therefore the process skips over step S6 to step S7.

(G) As shown in FIG. 8, the positions (3-10, 3-11) on an image and simulated image, at which the image level reaches respective predetermined threshold values (3-8, 3-9), are plotted. If the difference between the area of the region defined by the position (3-10) and the area of the region defined by the position (3-11) becomes minimum (3-16) when the corresponding pattern dimension, pattern configuration and pattern position included in design data are changed at step S7, it is determined that the images are identical to each other.

(H) As shown in FIG. 8, the positions (3-10, 3-11) on an image and simulated image, at which the image level reaches respective predetermined threshold values (3-8, 3-9), are plotted. If the distance (3-12) between an arbitrary point in the position (3-10) and the point in the position (3-11) closest to the arbitrary point becomes minimum (3-16) when the corresponding pattern dimension, pattern configuration and pattern position included in design data are changed at step S7, it is determined that the images are identical to each other. Alternatively, if a value corresponding to the displacement, such as the area of the region (3-17) defined by plotting in the positions (3-10) and (3-11), becomes minimum (3-16) when the corresponding pattern dimension, pattern configuration and pattern position included in design data are changed at step S7, it is determined that the images are identical to each other. Alternatively, if a value representing the maximum or average value of the displacements at all points in the position (3-10) becomes minimum (3-16) as shown in FIG. 9C when the corresponding pattern dimension, pattern configuration and pattern position included in design data are changed at step S7, it is determined that the images are identical to each other. However, if the process at step S5 is performed for the first time, the maximum or average value cannot be calculated, therefore the process skips over step S6 to step S7.

If it is determined at step S6 that the images are identical, the process proceeds to step S8. If, on the other hand, it is determined that the images are not identical, the corresponding pattern dimension, configuration and position included in photomask design data are changed, and the process returns to step S5.

At step S8, the pattern dimension corresponding to the dimension measuring position included in the finally obtained (changed) photomask design data is output as a measured pattern dimension. After that, the operator takes the photomask out of the microscope, and finishes the process.

As described above, in the embodiment, an image obtained by photographing a pattern on a photomask using an optical microscope is compared with a simulated image obtained from design data, and the corresponding pattern dimension, for example, included in the design data is changed so that the comparison result satisfies a predetermined comparison standard. As a result, a measured pattern dimension is acquired from the pattern dimension included in the finally obtained design data.

In this case, even if the resolution of the optical microscope is insufficient for a to-be-measured pattern, it is reflected in a simulated image to thereby prevent errors due to the insufficient resolution. Therefore, a to-be-inspected pattern on a photomask can be accurately measured even if it is very small. The measured value is very reliable.

The invention is not limited to the above-described embodiment. Although in the embodiment, a comparison result concerning an image and simulated image is referred to for changing the corresponding pattern dimension, configuration and position, it is sufficient if only the pattern dimension is changed, in a case where there is little displacement in pattern configuration and position between an image and simulated image. Further, the determination conditions for comparing an image and simulated image may appropriately include any of image levels, integral values of an image level distribution, areas, displacements, etc., explained in the embodiment. Furthermore, the configuration of the dimension measuring system is not limited to that shown in FIG. 1, but may be modified in various ways in accordance with the specification of the system.

Yet further, the method employed in the embodiment may be realized as a program for instructing a computer to carry out it. For installing the program in various apparatus, it may be written to recording mediums, such as magnetic disks (a floppy disk, hard disk, etc.), optical disks (a CD-ROM, DVD, etc.), semiconductor memories. Computers serving as these apparatuses read the program from a recording medium, and operate in accordance with the program to perform the above-described process.

The method of the invention can be used as a pattern configuration measuring method, using finally output design data. As an example of use of the output (changed) design data, an image transferred onto a wafer may be calculated from the output design data.

In addition, the method of the invention can be also used for manufacturing a photomask by modifying image drawing data for the photomask to correct the difference between original design data and output (changed) design data. Alternatively, the method can be used for the manufacture by modifying image drawing data for the photomask to correct the difference between an image transferred onto a wafer, based on the output design data, and a desired transfer image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A dimension measuring method of measuring a dimension of a pattern on a photomask subjected to pattern exposure for a semiconductor device, comprising:
acquiring, using an optical microscope, an image containing the pattern on the photomask;
acquiring a simulated image from photomask design data corresponding to the image acquired by the optical microscope, by simulating an image to be acquired by the optical microscope;
comparing the image acquired by the optical microscope with the simulated image acquired by the simulation, based on a predetermined determination condition;
determining a pattern dimension, included in the photomask design data, to be a measured pattern dimension, if the comparison result satisfies the determination condition; and
repeating, until the comparison result satisfies the determination condition, an operation of acquiring the simulated image and comparing the image acquired by the optical microscope with the simulated image after changing the pattern dimension included in the photomask design data, if the comparison result does not satisfy the determination condition, thereby determining, to be the measured pattern dimension, a pattern dimension included in finally obtained photomask design data.

2. The dimension measuring method according to claim 1, further comprising changing a pattern configuration and a pattern position included in the photomask design data, as well as the pattern dimension included in the photomask design data, before repeating the operation of acquiring the simulated image and comparing the image acquired by the optical microscope with the simulated image.

3. The dimension measuring method according to claim 1, wherein the acquiring the simulated image includes replacing a designed value of an optical characteristic, included in the photomask design data, with a pre-measured value of the optical characteristic or a value corresponding to a measured value other than the pre-measured value, revising the photomask design data and acquiring a simulated image from the revised photomask design data.

4. The dimension measuring method according to claim 1, wherein the determination condition for comparing the image and the simulated image is whether a difference in image level between the image and the simulated image falls within a predetermined range.

5. The dimension measuring method according to claim 1, wherein the determination condition for comparing the image and the simulated image is whether a difference between integral values of image levels contained in image level distributions of the image and the simulated image in a certain region falls within a predetermined range.

6. The dimension measuring method according to claim 1, wherein the determination condition for comparing the image and the simulated image is whether a difference between an area defined by positions in which a level of the image reaches a predetermined threshold value, and an area defined by positions in which a level of the simulated image reaches a predetermined threshold value, falls within a predetermined range.

7. The dimension measuring method according to claim 1, wherein the determination condition for comparing the image and the simulated image is whether an area defined by positions in which a level of the image reaches a predetermined threshold value, and positions in which a level of the simulated image reaches a predetermined threshold value, falls within a predetermined range.

8. The dimension measuring method according to claim 1, wherein the determination condition for comparing the image and the simulated image is whether a displacement between a position in which a level of the image reaches predetermined threshold value, and a position in which a level of the simulated image reaches a predetermined threshold value, falls within a predetermined range.

9. The dimension measuring method according to claim 1, wherein the determination condition for comparing the image and the simulated image is whether a value corresponding to a displacement between a position in which a level of the image reaches predetermined threshold value, and a position in which a level of the simulated image reaches a predetermined threshold value, falls within a predetermined range.

10. The dimension measuring method according to claim 1, wherein the determination condition for comparing the image and the simulated image is whether a difference in image level between the image and the simulated image, or a value representing the difference becomes minimum when the pattern dimension included in the photomask design data is changed.

11. The dimension measuring method according to claim 1, wherein the determination condition for comparing the image and the simulated image is whether a difference between integral values of image levels contained in image level distributions of the image and the simulated image in a certain region becomes minimum when the pattern dimension included in the photomask design data is changed.

12. The dimension measuring method according to claim 1, wherein the determination condition for comparing the image and the simulated image is whether a difference between an area defined by positions in which a level of the image reaches a predetermined threshold value, and an area defined by positions in which a level of the simulated image reaches a predetermined threshold value, becomes minimum when the pattern dimension included in the photomask design data is changed.

13. The dimension measuring method according to claim 1, wherein the determination condition for comparing the image and the simulated image is whether an area defined by positions in which a level of the image reaches a predetermined threshold value, and positions in which a level of the simulated image reaches a predetermined threshold value, becomes minimum when the pattern dimension included in the photomask design data is changed.

14. The dimension measuring method according to claim 1, wherein the determination condition for comparing the image and the simulated image is whether a displacement between a position in which a level of the image reaches predetermined threshold value, and a position in which a level of the simulated image reaches a predetermined threshold value, becomes minimum when the pattern dimension included in the photomask design data is changed.

15. The dimension measuring method according to claim 1, wherein the determination condition for comparing the image and the simulated image is whether a value corresponding to a displacement between a position in which a level of the image reaches predetermined threshold value, and a position in which a level of the simulated image reaches a predetermined threshold value, becomes minimum when the pattern dimension included in the photomask design data is changed.

16. A dimension measuring system for measuring a dimension of a pattern on a photomask subjected to pattern exposure for a semiconductor device, comprising:
an image acquisition section which acquires, using an optical microscope, an image containing the pattern on the photomask;
a simulated-image acquisition section which acquires a simulated image from photomask design data corresponding to the image acquired by the image acquisition section, by simulating an image to be acquired by the optical microscope;
a comparator which compares the image acquired by the image acquisition section with the simulated image acquired by the simulated-image acquisition section, based on a predetermined determination condition;
a change section which changes a pattern dimension included in the photomask design data such that the comparison result of the comparator satisfies the determination condition; and
an output section which outputs, as a measured pattern dimension value, a pattern dimension included in photomask design data finally changed by the change section.

17. The dimension measuring system according to claim 16, wherein the change section changes a pattern configuration and a pattern position included in the photomask design data, as well as the pattern dimension included in the photomask design data.

18. The dimension measuring system according to claim 16, wherein the simulated-image acquisition section replaces a designed value of an optical characteristic, included in the photomask design data, with a pre-measured value of the optical characteristic or a value corresponding to a measured value other than the pre-measured value, thereby revising the photomask design data and acquiring a simulated image from the revised photomask design data.

19. The dimension measuring system according to claim 16, wherein the change section uses, for the determination condition, a difference in image level between the image and the simulated image, and determines whether the difference falls within a predetermined range.

20. A program stored in a computer readable recording medium, which enables a computer to measure a dimension of a pattern on a photomask subjected to pattern exposure for a semiconductor device, the program instructing the computer to perform the following (A) to (E):
(A) receiving, from an optical microscope, an image containing the pattern on the photomask;
(B) acquiring a simulated image from photomask design data corresponding to the received image, by simulating an image to be acquired by the optical microscope;
(C) comparing the image with the simulated image based on a predetermined determination condition;
(D) changing a pattern dimension included in the photomask design data, and executing the steps (B) and (C);
(E) repeating the step (D) until the comparison result satisfies the determination condition, and determining, to be a measured pattern dimension, a pattern dimension included in finally obtained photomask design data.

21. A configuration measuring method of measuring a configuration of a pattern on a photomask subjected to pattern exposure for a semiconductor device, comprising:
acquiring, using an optical microscope, an image containing the pattern on the photomask;
acquiring a simulated image from photomask design data corresponding to the image acquired by the optical microscope, by simulating an image to be acquired by the optical microscope;
comparing the image acquired by the optical microscope with the simulated image acquired by the simulation, based on a predetermined determination condition;
outputting the photomask design data as a pattern configuration if the comparison result satisfies the determination condition; and
repeating, until the comparison result satisfies the determination condition, an operation of acquiring the simulated image and comparing the image acquired by the optical microscope with the simulated image after changing a pattern configuration included in the photomask design data, if the comparison result does not satisfy the determination condition, thereby outputting, as a measured pattern configuration, a pattern configuration included in finally obtained photomask design data.

22. A photomask manufacturing method for drawing a pattern of a semiconductor circuit on a mask substrate, comprising:
acquiring, using an optical microscope, an image containing the pattern on a photomask;
acquiring a simulated image from photomask design data corresponding to the image acquired by the optical microscope, by simulating an image to be acquired by the optical microscope;
comparing the image acquired by the optical microscope with the simulated image acquired by the simulation, based on a predetermined determination condition;
outputting the photomask design data as a pattern configuration if the comparison result satisfies the determination condition;
repeating, until the comparison result satisfies the determination condition, an operation of acquiring the simulated image and comparing the image acquired by the optical microscope with the simulated image after changing a pattern configuration included in the photomask design data, if the comparison result does not satisfy the determination condition, thereby outputting, as a measured pattern configuration, a pattern configuration included in finally obtained photomask design data; and
drawing a pattern on a mask substrate based on the output photomask design data.
